(19) United States
(12) Patent Application Publication
(10) Pub. No.: US 2025/0076470 A1
(43) Pub. Date: Mar. 6, 2025

(54) METHOD OF CONTROLLING BEAM STEERING AND MEASUREMENT ACQUISITION FOR SCANNING APPLICATIONS

(71) Applicant: Lumentum Operations LLC, San Jose, CA (US)

(72) Inventors: Sylvain LEDUC, Gatineau (CA); David KWONG, Gloucester (CA)

(21) Appl. No.: 18/501,188

(22) Filed: Nov. 3, 2023

Related U.S. Application Data
(60) Provisional application No. 63/535,895, filed on Aug. 31, 2023.

(51) Int. Cl. G01S 7/481; G01S 17/08; G06F 3/04847; G06F 40/166; G06T 11/00

(52) U.S. Cl. CPC G01S 7/4817; G01S 17/08; G06F 3/04847; G06F 40/166; G06T 11/00; G06T 2200/24

(57) ABSTRACT

A beam scanning control system includes a motion compiler, a localization assembler, and a controller. The motion compiler receives a high-level descriptive language defining a plurality of scanning regions of a scanning area and a plurality of scanning parameter subsets corresponding to the plurality of scanning regions, calculates a two-dimensional (2D) scanning pattern based on the high-level descriptive language, and generates assembly instructions based on the 2D scanning pattern. Each scanning parameter subset corresponds to a respective scanning region of the plurality of scanning regions. The localization assembler compiles the assembly instructions into machine instructions based on one or more characteristics of a 2D scanning system. The controller executes the machine instructions, and, based on executing the machine instructions, generates control signals for controlling the 2D scanning system to perform a 2D scan of the scanning area according to the 2D scanning pattern.

### CROSS-REFERENCE TO RELATED APPLICATION

This Patent application claims priority to U.S. Patent Application No. 63/535,895, filed on Aug. 31, 2023, and entitled “METHOD OF BEAM STEERING FOR SCANNING APPLICATIONS.” The disclosure of the prior Application is considered part of and is incorporated by reference into this Patent Application.

### TECHNICAL FIELD

The present disclosure relates generally to beam scanning systems and methods for controlling beam scanning systems.

### BACKGROUND

A scanning system may use two-dimensional (2D) scanning to scan one or more light beams within a field-of-view (FOV) according to a scanning pattern. The scanning system may use two scanning axes, including a first scanning axis that is configured to steer the one or more light beams in a first direction at a first scanning frequency and a second scanning axis that is configured to steer the one or more light beams in a second direction at a second scanning frequency. The second scanning axis is typically perpendicular to the first scanning axis. Transmitted light beams may be reflected back to the scanning system from one or more objects in the FOV as reflected light beams. A three-dimensional (3D) image of a scanned scene or a scanned object can then be generated based on distance measurements corresponding to the transmitted/reflected light beams. Additionally, or alternatively, the reflected light beams may be used by the scanning system to detect objects within the FOV for further processing.

### SUMMARY

In some implementations, a beam scanning control system includes a motion compiler configured to receive a high-level descriptive language defining a plurality of scanning regions of a scanning area and a plurality of scanning parameter subsets corresponding to the plurality of scanning regions, wherein each scanning parameter subset corresponds to a respective scanning region of the plurality of scanning regions, wherein each scanning parameter subset is defined by scanning parameter values for a plurality of scanning parameters for the respective scanning region, wherein the motion compiler is further configured to calculate a 2D scanning pattern based on the high-level descriptive language, and generate assembly instructions based on the 2D scanning pattern; a localization assembler configured to receive the assembly instructions, and compile the assembly instructions into machine instructions based on one or more characteristics of a 2D scanning system; and a controller comprising a processor configured to execute the machine instructions, and, based on executing the machine instructions, generate control signals for controlling the 2D scanning system to perform a 2D scan of the scanning area according to the 2D scanning pattern.

In some implementations, a method of controlling a beam scanning operation includes receiving, by a motion compiler, a high-level descriptive language defining a plurality of scanning regions of a scanning area and a plurality of scanning parameter subsets corresponding to the plurality of scanning regions, wherein each scanning parameter subset corresponds to a respective scanning region of the plurality of scanning regions, wherein each scanning parameter subset is defined by scanning parameter values for a plurality of scanning parameters for the respective scanning region, calculating, by the motion compiler, a 2D scanning pattern based on the high-level descriptive language, and generate assembly instructions based on the 2D scanning pattern; compiling, by a localization assembler, the assembly instructions into machine instructions based on one or more characteristics of a 2D scanning system; executing, by a controller, the machine instructions; and based on executing the machine instructions, generating, by the controller, control signals for controlling the 2D scanning system to perform a 2D scan of the scanning area according to the 2D scanning pattern.

### BRIEF DESCRIPTION OF THE DRAWINGS

FIG. 1 is a schematic block diagram of a 2D scanning system according to one or more implementations.

FIG. 2 is a schematic block diagram of a beam scanning control system according to one or more implementations.

FIG. 3 is a flow diagram of a beam scanning control method according to one or more implementations.

FIG. 4 illustrates an example scanning area with an example 2D scanning pattern superimposed on the scanning area.

### DETAILED DESCRIPTION

The following detailed description of example implementations refers to the accompanying drawings. The same reference numbers in different drawings may identify the same or similar elements.

A 2D scan may be used to scan a 3D scene or a 3D object. While light may be scanned in two dimensions, a third dimension (e.g., a depth dimension) may be obtained from distance measurements. The distance measurements may be performed based on a time-of-flight of transmitted and reflected light beams. Traditional methods for steering a light beam for a 2D scan involve pre-determined start and stop positions, a pre-determined, fixed measurement acquisition rate, and a few additional parameters that may be pre-configured based on implementation. A scanning pattern is then repeated, line after line, until a 2D scan is completed. This approach has several pitfalls.

First, entire areas of a 2D scan may be wasted on regions with nothing to measure, such as a surface of a car window. Thus, a large number of measurements may be unnecessarily performed on surfaces with low geometry. Second, for traditional scans with a fixed number of points, achieving a high density of measurements would require scanning a smaller surface because a distance between measurements cannot be modified in real-time, on the fly. Third, due to limitations of fixed scanning algorithms, multiple scans may be necessary for scanning an entire FOV (e.g., a 3D scene or a 3D object) that has multiple features of interest, which increases scanning times and increases an amount of memory storage needed to store measurement data, which may include non-essential data obtained from features with low geometry.

Thus, one or more issues with existing scanners translate into tradeoffs. The traditional methods may achieve high precision on small surfaces, but not on large surfaces. The traditional methods may scan large surfaces, but waste measurements on areas where there is no feature of interest to measure. Additionally, the traditional methods may perform a scan quickly to cover a large surface, but may do so with lower precision.

Some implementations provide a control method for steering light beams for 2D scans using a purpose-built programming language and processor. The control method may allow multiple parameters to be controlled dynamically while scanning a 3D scene or a 3D object. For example, parameters may include beam trajectory, beam speed, measurement acquisition rate, focal length, and integration time. Thus, the control method provides an ability to modify the parameters per measurement (e.g., on a light beam-by-light beam basis) or per scanning region of a scanning area for maximizing a usefulness and an efficiency of the 2D scan.

The control method differs from the traditional method by providing an ability to more efficiently scan one or more objects within a 3D scene or one or more features of a single object, while keeping the scan time near a physical limit that the 2D scanner can provide. In addition, the control method may reduce a number of measurements acquired from objects or features that have low geometry in order to reduce an amount of measurement data and reduce an amount of memory storage needed to store the measurement data. Smaller amounts of measurement data may also lead to faster processing times, with less measurement data to be processed by the 2D scanner.

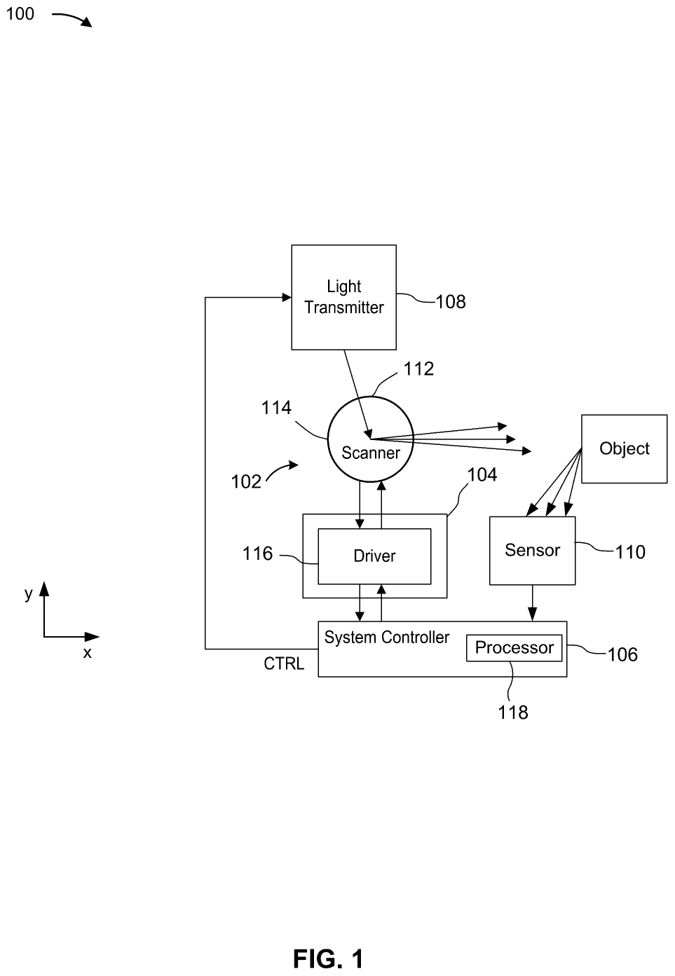

FIG. 1 is a schematic block diagram of a 2D scanning system 100 according to one or more implementations. In particular, the 2D scanning system 100 includes a scanner 102 configured to steer or otherwise deflect light beams according to a 2D scanning pattern for scanning 3D objects. The 2D scanning system 100 further includes a driver system 104, a system controller 106, and a light transmitter 108, and a sensor 110.

In the example shown in FIG. 1, the scanner 102 may be a mechanical moving mirror and may be configured to rotate or oscillate via rotation about two scanning axes that are typically orthogonal to each other. For example, the two scanning axes may include a first scanning axis 112 that enables the scanner 102 to steer light in a first scanning direction (e.g., an x-direction) and a second scanning axis 114 (e.g., an inner scanning axis) that enables the scanner 102 to steer light in a second scanning direction (e.g., a y-direction). As a result, the scanner 102 can direct light beams in two dimensions according to the 2D scanning pattern.

A scan can be performed to illuminate an area referred to as a field-of-view. The scan, such as an oscillating horizontal scan (e.g., from left to right and right to left of a field-of-view), an oscillating vertical scan (e.g., from bottom to top and top to bottom of a field-of-view), or a combination thereof (e.g., a Lissajous scan or a raster scan) can illuminate the field-of-view in a continuous scan fashion. In some implementations, the 2D scanning system 100 may be configured to transmit successive light beams (e.g., as successive light pulses) in different scanning directions to scan the field-of-view. The scanner 102 can direct a transmitted light beam at a desired 2D measurement coordinate (e.g., an x-y coordinate) in the field-of-view, controlled by the system controller 106.

In some implementations, the scanner 102 may be arranged to receive transmitted light beams from the light transmitter 108 and steer (scan) the transmitted light beams into the field-of-view to perform a scanning of the environment. The transmitted light beams may be backscattered by one or more objects back toward the 2D scanning system 100 as reflected light beams, where the reflected light beams are detected by the sensor 110. For example, the sensor 110 may be a photodetector array. The sensor 110 may convert each reflected light beam into an electric signal (e.g., a current signal or a voltage signal) that may be further processed by the 2D scanning system 100 to generate object data or an image. In such implementations, the desired 2D measurement coordinate may correspond to a particular transmission direction in the field-of-view that is targeted by the transmitted light beam for object detection or scanning, with different 2D measurement coordinates corresponding to different transmission directions. The system controller 106 may receive electrical signals from the sensor and perform signal processing on the electrical signals for object feature detection.

Accordingly, multiple light beams transmitted at different transmission times can be steered by the scanner 102 at the different 2D measurement coordinates of the field-of-view in accordance with the 2D scanning pattern. The scanner 102 can be used to scan the field-of-view in both scanning directions by changing an angle of deflection of the scanner 102 on each of the first scanning axis 112 and the second scanning axis 114.

The driver system 104 may be configured to generate driving signals (e.g., actuation signals) to drive the scanner 102 about the first scanning axis 112 and the second scanning axis 114. In particular, the driver system 104 may be configured to apply the driving signals to an actuator structure of the scanner 102. In some implementations, the driver system 104 includes a driver 116 configured to drive the scanner 102 about the first scanning axis 112 and the second scanning axis 114. In implementations in which the scanner 102 is used as an oscillator, the driver 116 may be configured to drive an oscillation of the scanner 102 about the first scanning axis 112 at a first frequency, and drive an oscillation of the scanner 102 about the second scanning axis 114 at a second frequency.

The driver 116 may be configured to receive feedback information from the scanner 102, such as rotational position information. The system controller 106 may use the rotational position information to trigger light beams at the light transmitter 108. For example, the system controller 106 may use the rotational position information to set a transmission time of light transmitter 108 in order to target a particular 2D measurement coordinate of the 2D scanning pattern.

In some implementations, the system controller 106 is configured to set a driving frequency of the scanner 102 for each scanning axis and is capable of synchronizing the oscillations about the first scanning axis 112 and the second scanning axis 114. In particular, the system controller 106 may be configured to control an actuation of the scanner 102 about each scanning axis by controlling the driving signals. The system controller 106 may control the frequency, the phase, the duty cycle, and/or a voltage level of the driving signals to control the actuations about the first scanning axis 112 and the second scanning axis 114. The actuation of the scanner 102 about a particular scanning axis controls its range of motion and scanning rate about that particular scanning axis.

The light transmitter 108 may include one or more light sources, such as one or more laser diodes or one or more light emitting diodes, for generating one or more light beams. In some implementations, the light transmitter 108 may be configured to sequentially transmit a plurality of light beams (e.g., light pulses) as the scanner 102 changes its transmission direction in order to target different 2D measurement coordinates. The plurality of light beams may include visible light, infrared (IR) light, or other types of illumination signals, depending on an application of the 2D scanning system 100. A transmission sequence of the plurality of light beams and a timing thereof may be implemented by the light transmitter 108 according to a control signal CTRL received from the system controller 106.

The system controller 106 may be configured to control components of the 2D scanning system 100. In certain applications, the system controller 106 may also be configured to receive programming information with respect to the 2D scanning pattern and control a timing of the plurality of light beams generated by the light transmitter 108 based on the programming information. Thus, the system controller 106 may include both processing and control circuitry that is configured to generate control signals for controlling the light transmitter 108 and the driver 116. For example, the system controller 106 may include a processor 118 configured to execute machine instructions, and, based on executing the machine instructions, generate control signals for controlling the 2D scanning system 100 to perform a 2D scan of the scanning area according to the 2D scanning pattern. For example, the processor 118, in conjunction with control circuitry, may control the light transmitter 108 and the scanner 102 to target each 2D measurement coordinate with a respective light beam. The processor 118 may control the scanner 102 by controlling one or more parameters of the driver 116, such as the frequency, the phase, the duty cycle, and/or a voltage level of the driving signals used for driving each scanning axis 112 and 114.

The processor 118 may be a custom processor, a specialized processor, or a purpose-built processor configured to receive custom machine language instructions natively and execute the custom machine language instructions. The processor 118 may be designed specifically for executing the custom machine language instructions to perform a customized 2D scan, whereas a general-purpose processor may not be able to execute the custom machine language instructions to perform the customized 2D scan. The customized 2D scan may be customized for one or more characteristics of the 2D scanning system 100, as well as based on different levels of interest corresponding to different regions (e.g., regions of interest) within a scanning area. The processor 118 may be configured to, based on the custom machine language instructions, control and dynamically vary one or more scanning parameters in real-time while scanning the scanning area. In some implementations, the processor 118 may be implemented as an application-specific integrated circuit (ASIC), a field-programmable gate array (FPGA), or emulated in software executed on a custom processing device.

In some implementations, in which the plurality of light beams is used, the system controller 106 may be configured to generate the control signal CTRL used for triggering the light transmitter 108 to generate the plurality of light beams. Using the control signal CTRL, the system controller 106 can control the transmission times of the plurality of light beams of the light transmitter 108 to achieve a desired illumination pattern within the field-of-view. The desired illumination pattern is produced by a combination of the 2D scanning pattern produced by the scanner 102 and the transmission times triggered by the system controller 106.

In some implementations, the object data may be used during a manufacturing process of an object (e.g., a vehicle) to detect whether a part is assembled correctly and/or satisfies one or more specifications. Thus, the object data may be used to detect manufacturing faults that may occur during the manufacturing process.

Accordingly, the 2D scanning system 100 may include a detector that includes at least one sensor (e.g., sensor 110) and at least one signal processor (e.g., the processor 118 or other additional processors and/or processing components) implemented, for example, in the system controller 106. The sensor 110 may generate electrical signals based on reflected light beams corresponding to the light beams transmitted by the light transmitter 108. The sensor 110 may transmit the electrical signals to the at least one signal processor. The at least one signal processor may be configured to process the electrical signals to generate distance measurements based on the machine instructions for generating the object data. The at least one signal processor may be configured to analyze the object data based on the machine instructions to detect manufacturing faults.

As indicated above, FIG. 1 is provided as an example. Other examples may differ from what is described with regard to FIG. 1. In practice, the 2D scanning system 100 may include additional components, fewer components, different components, or differently arranged components than those shown in FIG. 1 without deviating from the disclosure provided above. In addition, in some implementations, the 2D scanning system 100 may include one or more additional mirrors to scan the field-of-view.

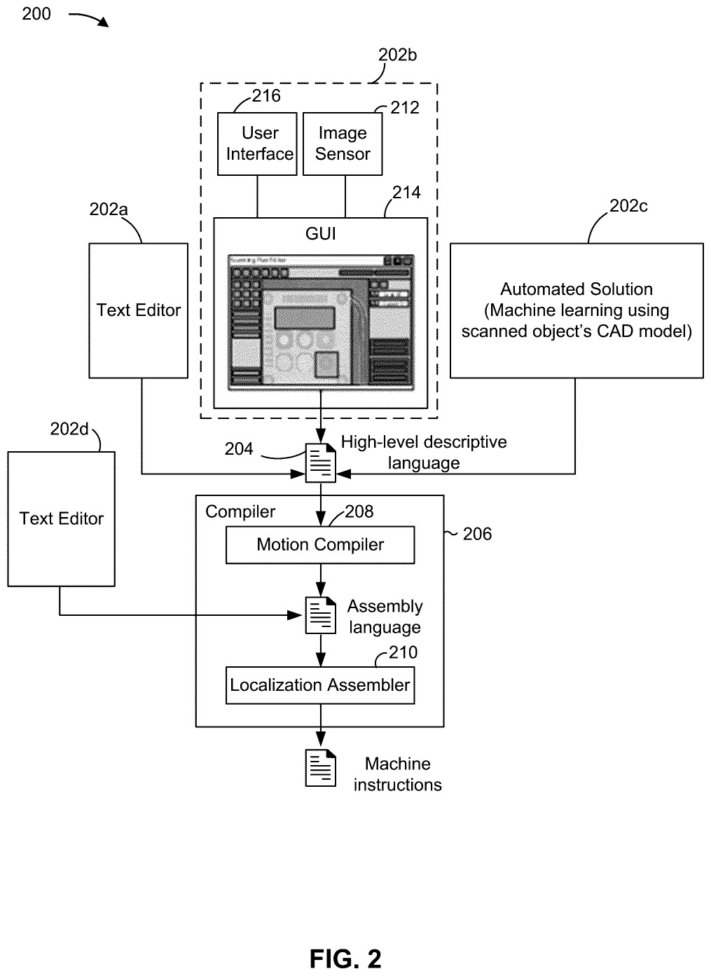

FIG. 2 is a schematic block diagram of a beam scanning control system 200 according to one or more implementations. The beam scanning control system 200 includes one or more input devices 202a, 202b, 202c, or 202d, an editor processor 204, and a compiler 206. The compiler 206 may include a motion compiler 208 and a localization assembler 210.

One or more of the input devices 202a, 202b, or 202c may include or may be operatively coupled to the editor processor 204 for generating a high-level descriptive language. The high-level descriptive language may provide an ability to generate a scanning program using vectorized shapes (rectangles, triangles, circles, etc.) and scanning parameters values for one or more scanning parameters, such as a measurement point density, a beam speed, a measurement acquisition rate, a focal length, or an integration time. The high-level descriptive language may define to a plurality of scanning regions of the scanning area and a plurality of scanning parameter subsets corresponding to the plurality of scanning regions, where each scanning parameter subset corresponds to a respective scanning region of the plurality of scanning regions, and where each scanning parameter subset is defined by scanning parameter values for a plurality of scanning parameters for the respective scanning region.

One or more of the input devices 202a, 202b, or 202c may be configured to define vectorized shapes for the plurality of scanning regions, and define the scanning parameter values for each scanning parameter subset. Each vectorized shape may define a respective scanning region of the plurality of scanning regions of the scanning area.

The input device 202a may include a text editor configured to receive the high-level descriptive language (e.g., from user input) and provide the high-level descriptive language to the motion compiler 208. The input device 202a may include the editor processor 204 for generating the high-level descriptive language based on the user input.

The input device 202b may include an image sensor 212 configured to generate an image of a target object, a display 214 configured to display the image and a graphical user interface (GUI) overlaid on the image, and a user interface 216, such as a keyboard, a mouse, and/or a touch screen configured to receive user input that defines the vectorized shapes in the graphical user interface and the scanning parameter values of the plurality of scanning parameter subsets. For example, a user may use the user interface 216 to draw or otherwise define the vectorized shapes on the GUI. Each vectorized shape may correspond to a respective scanning region of the plurality of scanning regions of the scanning area. In addition, the input device 202b may include at least one processor (e.g., the editor processor 204) configured to generate the high-level descriptive language based on the user input.

The input device 202c may include at least one processor (e.g., the editor processor 204) configured to process, with a machine learning model, one or more geometric models of a target object to identify vectorized shapes corresponding to the target object and to define the scanning parameter values of the plurality of scanning parameter subsets. For example, the at least one processor may electronically receive one or more computer-aided drafting (CAD) models as the one or more geometric models, and may analyze the one or more CAD models with the machine learning model to identify the vectorized shapes and to determine the scanning parameter values based on the vectorized shapes. Each vectorized shape may correspond to a respective scanning region of the plurality of scanning regions of the scanning area. In addition, the at least one processor may generate, with the machine learning model, the high-level descriptive language based on the vectorized shapes and the scanning parameter values of the plurality of scanning parameter subsets.

The motion compiler 208 may receive the high-level descriptive language, calculate a 2D scanning pattern based on the high-level descriptive language, and generate assembly instructions based on the 2D scanning pattern. The assembly language may be any low-level programming language with a high-level of correspondence between the high-level descriptive language and machine instructions (e.g., a processor instruction set). Each machine language instruction may have a one-to-one correlation to a unique mnemonic representation of the command provided in the assembly language.

The assembly instructions may be product family specific. In other words, the assembly instructions may be generated for a specific product that is intended to be a target of a 2D scan. Thus, different assembly instructions may be generated for different products or different product families. In some implementations, the input device 202d (e.g., a text editor) may provide additional assembly instructions or modifications to the assembly instructions.

The localization assembler 210 may receive the assembly instructions, and compile the assembly instructions into the machine instructions (e.g., custom machine language instructions) based on one or more characteristics of a 2D scanning system (e.g., the 2D scanning system 100). The localization assembler 210 may generate the machine instructions based on the one or more characteristics of the 2D scanning system 100 such that a scan time of the 2D scan is minimized based on one or more physical limits of the 2D scanning system 100. The one or more physical limits may correspond to one or more characteristics of the scanner 102, one or more characteristics of the light transmitter 108, and/or one or more characteristics of the sensor 110.

The machine instructions may be a set of low-level machine language instructions for the processor 118 to perform a scan and to perform related setup and signal processing as directed by the set of low-level machine language instructions. The machine instructions may include, but are not limited to, memory access, variable assignment, variable manipulation, flow control, task/event sequencing, complex commands utilizing variables/parameters/memory, mathematical operators, comparison operators, and specialized commands. For example, the processor 118 may execute the machine instructions, and, based on executing the machine instructions, generate control signals for controlling the 2D scanning system 100 to perform the 2D scan of the scanning area according to the 2D scanning pattern.

The 2D scanning pattern includes a trajectory of the 2D scanning pattern and 2D measurement coordinates within each scanning region of the plurality of scanning regions. Accordingly, each 2D measurement coordinate is located on the trajectory. The processor 118, based on executing the machine instructions, may control the light transmitter 108 and the scanner 102 to target each 2D measurement coordinate with a respective light beam.

The plurality of scanning parameters may include the measurement point density that defines a density of the 2D measurement coordinates. Thus, each vectorized shape or scanning region within the scanning area may be associated with a corresponding measurement point density. Thus, a scanning region with low-geometry features (e.g., features with no or low-degree of variance in geometry) may be associated with a low measurement point density provided by one or more of the input devices 202a, 202b, or 202c. In contrast, a scanning region with high-geometry features (e.g., features with a high-degree of variance in geometry) may be associated with a high measurement point density provided by one or more of the input devices 202a, 202b, or 202c. In some implementations, each scanning region may be associated with two or more scanning parameter values for a plurality of scanning parameters.

In some implementations, the high-level descriptive language may define each scanning region of the plurality of scanning regions as a vectorized shape having a defined contour. In addition, the 2D scanning pattern may include a plurality of scanning patterns, with each scanning pattern of the plurality of scanning patterns being bound by the defined contour of a respective vectorized shape. In other words, different scanning patterns within the scanning area may be created by the motion compiler 208 for different scanning regions. Thus, the scanning pattern may change as the 2D scan progresses from one scanning region to another scanning region withing a same scanning cycle. As a result, the trajectory of the 2D scanning pattern may not be uniform throughout the scanning area, but may vary according to the different scanning patterns. The motion compiler 208 may link each of the different scanning patterns with a respective scanning parameter subset. Thus, the motion compiler 208 may calculate the different scanning patterns based on the high-level descriptive language. The assembly language may define the different scanning patterns, the scanning region of each scanning pattern, and the respective scanning parameter subset of each scanning pattern based on the high-level descriptive language.

The machine instructions set may be stored on a storage medium (e.g., a memory device) of the system controller 106 or on a storage medium the system controller 106 can access (e.g., by read operations). Thus, the compiler 206 may provide the machine instructions to the system controller 106, which stores the machine instructions in memory for execution by the processor 118, or to another memory device.

As indicated above, FIG. 2 is provided as an example. Other examples may differ from what is described with regard to FIG. 2.

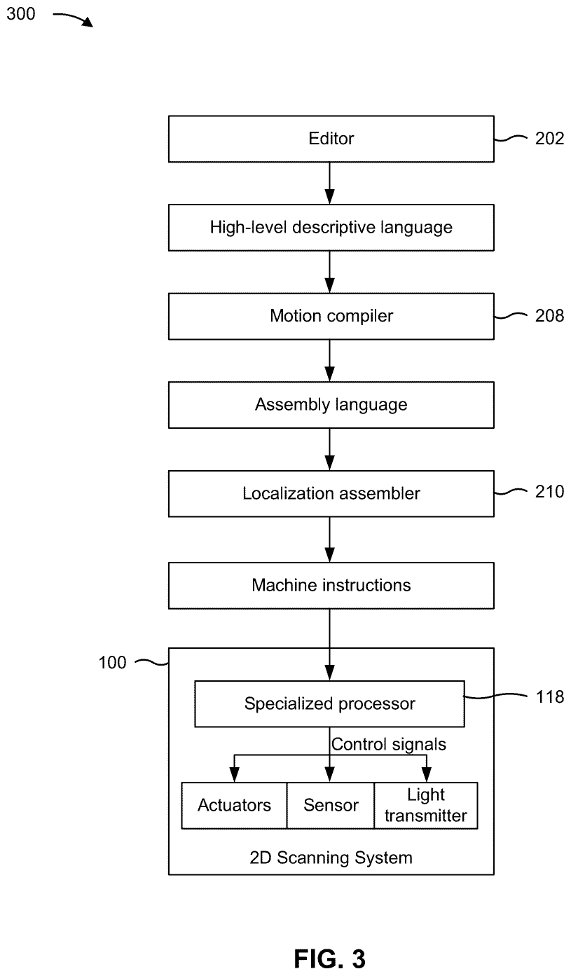

FIG. 3 is a flow diagram 300 of a beam scanning control method according to one or more implementations. An input device 202, such as input device 202a, input device 202b, or input device 202c, is configured to provide the high-level descriptive language to the motion compiler 208. The motion compiler 208 is configured to calculate a 2D scanning pattern based on the high-level descriptive language, and generate assembly instructions based on the 2D scanning pattern. The motion compiler 208 is configured to provide the assembly instructions to the localization assembler 210. The localization assembler 210 is configured to compile the assembly instructions into machine instructions based on one or more characteristics of a 2D scanning system 100, and provide the machine instructions to the processor 118 of the system controller 106. The processor 118 is configured to execute the machine instructions, and, based on executing the machine instructions, the system controller 106 is configured to generate control signals for controlling the 2D scanning system 100 to perform a 2D scan of the scanning area according to the 2D scanning pattern. The control signals may be used to control one or more actuators (e.g., one or more actuators of the scanner 102), one or more sensors (e.g., sensor 110), and/or one or more light transmitters (e.g., light transmitter 108).

As indicated above, FIG. 3 is provided as an example. Other examples may differ from what is described with regard to FIG. 3.

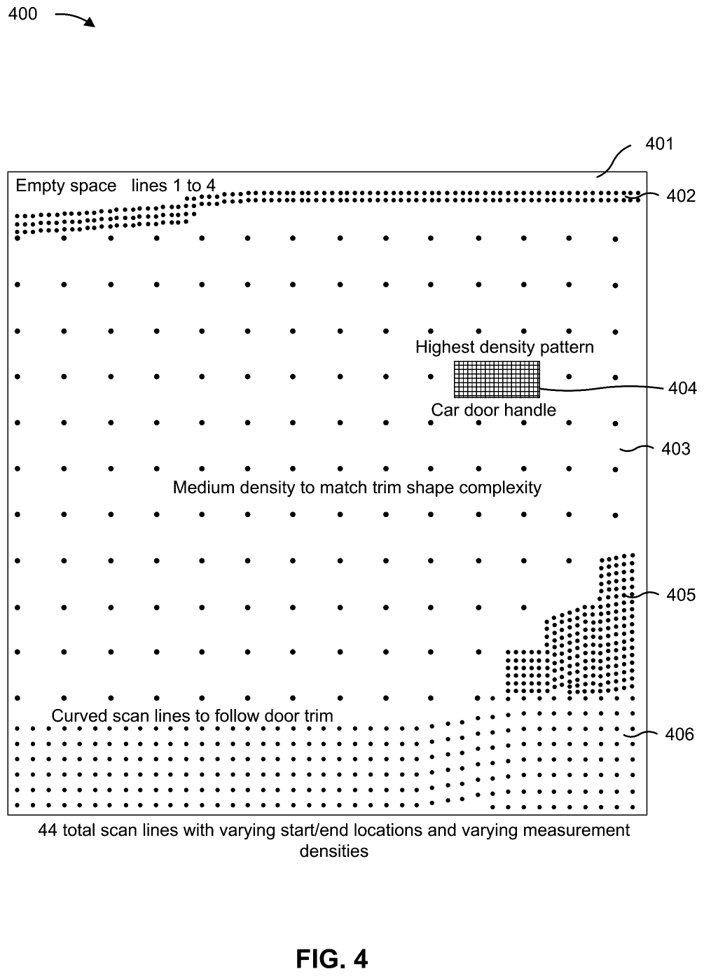

FIG. 4 illustrates an example scanning area 400 with an example 2D scanning pattern superimposed on the scanning area 400. The 2D scanning pattern may be used by the scanning system 100 for performing a 2D scan of the scanning area 400. Each dot is representative of a measurement point (e.g., a 2D measurement coordinate) corresponding to a transmitted light beam. The measurement points are overlaid on top of a 3D object to be scanned, such as a car door. Measurements may be maximized by increasing a measurement point density over regions of the 3D object that have fine details, such as a car door handle, and by lowering the measurement point density over regions of the 3D object that have low geometry, such as a car body panel, and by skipping over regions of the 3D object with no surface geometry (e.g., no changes in geometry), such as a car door window frame.

In addition, the measurements may be maximized by following curved object features and/or following contours of object features, such as door trims. The scan lines across the field-of-view (e.g., the scanning area) may include high density areas, low density areas, and skipped areas. In addition, scan lines may be straight, curved, or contoured to follow outlines of object features of the 3D object. Using the control signals CTRL, the system controller 106 may control the transmission times of the plurality of light beams of the light transmitter 108 to achieve a desired illumination pattern within the field-of-view. The desired illumination pattern may be produced by a combination of the 2D scanning pattern produced by the scanner 102 and the transmission times triggered by the system controller 106.

The scanning area 400 may include plurality of scanning regions 401-406, each of which may have a different scanning pattern associated therewith. In scanning region 401, the measurement point density may be set to zero such that no scanning is performed in the scanning region 401. In scanning region 402, the measurement point density may be set to a scanning parameter value corresponding to a level of detail to be scanned. Similarly, the measurement point density may be set to scanning parameter values corresponding to a level of detail to be scanned within each of the scanning regions 403-406. Moreover, each scanning pattern of the different scanning patterns may be bound by a defined contour of a respective vectorized shape.

Thus, a method of beam steering may use a purpose-built programmable language and a processor, which allows a user to determine precisely where and how every measurement of a scanning pattern is to be obtained. The method may enable the 2D scanning system 100 to perform faster scans of larger surfaces, with high precision, with a least amount of memory, and without non-useful measurements. In addition, the method may enable the 2D scanning system 100 to scan 3D objects by using a 2D scanning pattern that follows complex contours of object features.

Some implementations provide a scanner control method for enhanced scanning performance, accuracy, and faster data acquisition. The scanner control method may allow for greater adaptability to various object sizes and surface properties, improving a versatility of the 2D scanning system. The scanner control method may incorporate advanced algorithms for real-time processing, debugging, and calibration to ensure consistent scan quality. Overall, the scanner control method may provide significant benefits in terms of speed, precision, and flexibility for a wide range of scanning applications.

The scanner control method may use a programming language coupled with a specialized processor for steering a beam for obtaining distance measurements. A method of motion planning (e.g., implemented as part of the compiler 206) may provide reduced scan times, improve scanning accuracy and precision, and take into account one or more characteristics of the scanner to operate at the scanner's physical limits.

The machine instructions, executed by a processor, may be used to control the hardware, sensors, internal memory, and control flow of the 3D scanning system 100.

Debugging facilities may be built into the programming language that provides advanced capabilities of controlling the hardware for investigative purposes or for collecting information during scans.

The scanner control method may use the graphical user interface for generating a scanning program automatically based on the vectorized shapes and the input parameters provided via the graphical user interface.

The following provides an overview of some Aspects of the present disclosure:

Aspect 1: A beam scanning control system, comprising: a motion compiler configured to receive a high-level descriptive language defining a plurality of scanning regions of a scanning area and a plurality of scanning parameter subsets corresponding to the plurality of scanning regions, wherein each scanning parameter subset corresponds to a respective scanning region of the plurality of scanning regions, wherein each scanning parameter subset is defined by scanning parameter values for a plurality of scanning parameters for the respective scanning region, wherein the motion compiler is further configured to calculate a two-dimensional (2D) scanning pattern based on the high-level descriptive language, and generate assembly instructions based on the 2D scanning pattern; a localization assembler configured to receive the assembly instructions, and compile the assembly instructions into machine instructions based on one or more characteristics of a 2D scanning system; and a controller comprising a processor configured to execute the machine instructions, and, based on executing the machine instructions, generate control signals for controlling the 2D scanning system to perform a 2D scan of the scanning area according to the 2D scanning pattern.

Aspect 2: The beam scanning control system of Aspect 1, wherein the 2D scanning pattern incudes a trajectory of the 2D scanning pattern and 2D measurement coordinates within each scanning region of the plurality of scanning regions, and wherein each 2D measurement coordinate is located on the trajectory.

Aspect 3: The beam scanning control system of Aspect 2, wherein the processor is configured to control a light transmitter and a scanner to target each 2D measurement coordinate with a respective light beam.

Aspect 4: The beam scanning control system of Aspect 2, wherein the plurality of scanning parameters includes a measurement point density that defines a density of the 2D measurement coordinates.

Aspect 5: The beam scanning control system of any of Aspects 1-4, wherein the high-level descriptive language defines each scanning region of the plurality of scanning regions as a vectorized shape having a defined contour.

Aspect 6: The beam scanning control system of Aspect 5, wherein the 2D scanning pattern comprises a plurality of scanning patterns, wherein each scanning pattern of the plurality of scanning patterns is bound by the defined contour of a respective vectorized shape.

Aspect 7: The beam scanning control system of any of Aspects 1-6, further comprising: an input device configured to define vectorized shapes for the plurality of scanning regions, and define the scanning parameter values for each scanning parameter subset.

Aspect 8: The beam scanning control system of Aspect 7, wherein each vectorized shape defines a respective scanning region of the plurality of scanning regions.

Aspect 9: The beam scanning control system of Aspect 7, wherein the plurality of scanning parameters includes two or more of a measurement point density, a beam speed, a measurement acquisition rate, a focal length, or an integration time.

Aspect 10: The beam scanning control system of Aspect 7, wherein the input device includes a text editor configured to receive the high-level descriptive language and provide the high-level descriptive language to the motion compiler.

Aspect 11: The beam scanning control system of Aspect 7, wherein the input device comprises: an image sensor configured to generate an image of a target object; a display configured to display the image and a graphical user interface overlaid on the image; and a user interface configured to receive user input that defines the vectorized shapes in the graphical user interface and the scanning parameter values of the plurality of scanning parameter subsets, wherein each vectorized shape corresponds to a respective scanning region of the plurality of scanning regions, and wherein the input device includes at least one processor configured to generate the high-level descriptive language based on the user input.

Aspect 12: The beam scanning control system of Aspect 7, wherein the input device comprises: at least one processor configured to process, with a machine learning model, one or more geometric models of a target object to identify vectorized shapes corresponding to the target object and to define the scanning parameter values of the plurality of scanning parameter subsets, wherein each vectorized shape corresponds to a respective scanning region of the plurality of scanning regions of the scanning area, and wherein the at least one processor is configured to generate, with the machine learning model, the high-level descriptive language based on the vectorized shapes and the scanning parameter values of the plurality of scanning parameter subsets.

Aspect 13: The beam scanning control system of any of Aspects 1-12, wherein the localization assembler is configured to generate the machine instructions based on the one or more characteristics of the 2D scanning system such that a scan time of the 2D scan is minimized based on one or more physical limits of the 2D scanning system.

Aspect 14: The beam scanning control system of any of Aspects 1-13, further comprising: a detector comprising at least one sensor and at least one signal processor, wherein the at least one sensor is configured to generate electrical signals based on reflected light beams transmitted by the 2D scanning system, and wherein the at least one signal processor is configured to process the electrical signals to generate distance measurements based on the machine instructions.

Aspect 15: A method of controlling a beam scanning operation, comprising: receiving, by a motion compiler, a high-level descriptive language defining a plurality of scanning regions of a scanning area and a plurality of scanning parameter subsets corresponding to the plurality of scanning regions, wherein each scanning parameter subset corresponds to a respective scanning region of the plurality of scanning regions, wherein each scanning parameter subset is defined by scanning parameter values for a plurality of scanning parameters for the respective scanning region, calculating, by the motion compiler, a two-dimensional (2D) scanning pattern based on the high-level descriptive language, and generate assembly instructions based on the 2D scanning pattern; compiling, by a localization assembler, the assembly instructions into machine instructions based on one or more characteristics of a 2D scanning system; executing, by a controller, the machine instructions; and based on executing the machine instructions, generating, by the controller, control signals for controlling the 2D scanning system to perform a 2D scan of the scanning area according to the 2D scanning pattern.

Aspect 16: The method of Aspect 15, wherein the 2D scanning pattern incudes a trajectory of the 2D scanning pattern and 2D measurement coordinates within each scanning region of the plurality of scanning regions, and wherein each 2D measurement coordinate is located on the trajectory.

Aspect 17: The method of Aspect 16, wherein the plurality of scanning parameters includes a measurement point density that defines a density of the 2D measurement coordinates.

Aspect 18: The method of any of Aspects 15-17, wherein the high-level descriptive language defines each scanning region of the plurality of scanning regions as a vectorized shape having a defined contour.

Aspect 19: The method of Aspect 18, wherein the 2D scanning pattern comprises a plurality of scanning patterns, and wherein each scanning pattern of the plurality of scanning patterns is bound by the defined contour of a respective vectorized shape.

Aspect 20: The method of any of Aspects 15-19, further comprising: providing, by an input device, vectorized shapes for the plurality of scanning regions; and providing, by the input device, the scanning parameter values for each scanning parameter subset, wherein each vectorized shape defines a respective scanning region of the plurality of scanning regions.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A beam scanning control system, comprising:
a motion compiler configured to receive a high-level descriptive language defining a plurality of scanning regions of a scanning area and a plurality of scanning parameter subsets corresponding to the plurality of scanning regions, wherein each scanning parameter subset corresponds to a respective scanning region of the plurality of scanning regions, wherein each scanning parameter subset is defined by scanning parameter values for a plurality of scanning parameters for the respective scanning region,
wherein the motion compiler is further configured to calculate a two-dimensional (2D) scanning pattern based on the high-level descriptive language, and generate assembly instructions based on the 2D scanning pattern;
a localization assembler configured to receive the assembly instructions, and compile the assembly instructions into machine instructions based on one or more characteristics of a 2D scanning system; and
a controller comprising a processor configured to execute the machine instructions, and, based on executing the machine instructions, generate control signals for controlling the 2D scanning system to perform a 2D scan of the scanning area according to the 2D scanning pattern.

2. The beam scanning control system of claim 1, wherein the 2D scanning pattern incudes a trajectory of the 2D scanning pattern and 2D measurement coordinates within each scanning region of the plurality of scanning regions, and
wherein each 2D measurement coordinate is located on the trajectory.

3. The beam scanning control system of claim 2, wherein the processor is configured to control a light transmitter and a scanner to target each 2D measurement coordinate with a respective light beam.

4. The beam scanning control system of claim 2, wherein the plurality of scanning parameters includes a measurement point density that defines a density of the 2D measurement coordinates.

5. The beam scanning control system of claim 1, wherein the high-level descriptive language defines each scanning region of the plurality of scanning regions as a vectorized shape having a defined contour.

6. The beam scanning control system of claim 5, wherein the 2D scanning pattern comprises a plurality of scanning patterns, wherein each scanning pattern of the plurality of scanning patterns is bound by the defined contour of a respective vectorized shape.

7. The beam scanning control system of claim 1, further comprising:
an input device configured to define vectorized shapes for the plurality of scanning regions, and define the scanning parameter values for each scanning parameter subset.

8. The beam scanning control system of claim 7, wherein each vectorized shape defines a respective scanning region of the plurality of scanning regions.

9. The beam scanning control system of claim 7, wherein the plurality of scanning parameters includes two or more of a measurement point density, a beam speed, a measurement acquisition rate, a focal length, or an integration time.

10. The beam scanning control system of claim 7, wherein the input device includes a text editor configured to receive the high-level descriptive language and provide the high-level descriptive language to the motion compiler.

11. The beam scanning control system of claim 7, wherein the input device comprises:
an image sensor configured to generate an image of a target object;
a display configured to display the image and a graphical user interface overlaid on the image; and
a user interface configured to receive user input that defines the vectorized shapes in the graphical user interface and the scanning parameter values of the plurality of scanning parameter subsets,
wherein each vectorized shape corresponds to a respective scanning region of the plurality of scanning regions, and
wherein the input device includes at least one processor configured to generate the high-level descriptive language based on the user input.

12. The beam scanning control system of claim 7, wherein the input device comprises:
at least one processor configured to process, with a machine learning model, one or more geometric models of a target object to identify vectorized shapes corresponding to the target object and to define the scanning parameter values of the plurality of scanning parameter subsets,
wherein each vectorized shape corresponds to a respective scanning region of the plurality of scanning regions of the scanning area, and
wherein the at least one processor is configured to generate, with the machine learning model, the high-level descriptive language based on the vectorized shapes and the scanning parameter values of the plurality of scanning parameter subsets.

13. The beam scanning control system of claim 1, wherein the localization assembler is configured to generate the machine instructions based on the one or more characteristics of the 2D scanning system such that a scan time of the 2D scan is minimized based on one or more physical limits of the 2D scanning system.

14. The beam scanning control system of claim 1, further comprising:
a detector comprising at least one sensor and at least one signal processor,
wherein the at least one sensor is configured to generate electrical signals based on reflected light beams transmitted by the 2D scanning system, and
wherein the at least one signal processor is configured to process the electrical signals to generate distance measurements based on the machine instructions.

15. A method of controlling a beam scanning operation, comprising:
receiving, by a motion compiler, a high-level descriptive language defining a plurality of scanning regions of a scanning area and a plurality of scanning parameter subsets corresponding to the plurality of scanning regions, wherein each scanning parameter subset corresponds to a respective scanning region of the plurality of scanning regions, wherein each scanning parameter subset is defined by scanning parameter values for a plurality of scanning parameters for the respective scanning region,
calculating, by the motion compiler, a two-dimensional (2D) scanning pattern based on the high-level descriptive language, and generate assembly instructions based on the 2D scanning pattern;
compiling, by a localization assembler, the assembly instructions into machine instructions based on one or more characteristics of a 2D scanning system;
executing, by a controller, the machine instructions; and
based on executing the machine instructions, generating, by the controller, control signals for controlling the 2D scanning system to perform a 2D scan of the scanning area according to the 2D scanning pattern.

16. The method of claim 15, wherein the 2D scanning pattern incudes a trajectory of the 2D scanning pattern and 2D measurement coordinates within each scanning region of the plurality of scanning regions, and
wherein each 2D measurement coordinate is located on the trajectory.

17. The method of claim 16, wherein the plurality of scanning parameters includes a measurement point density that defines a density of the 2D measurement coordinates.

18. The method of claim 15, wherein the high-level descriptive language defines each scanning region of the plurality of scanning regions as a vectorized shape having a defined contour.

19. The method of claim 18, wherein the 2D scanning pattern comprises a plurality of scanning patterns, and
wherein each scanning pattern of the plurality of scanning patterns is bound by the defined contour of a respective vectorized shape.

20. The method of claim 15, further comprising:
providing, by an input device, vectorized shapes for the plurality of scanning regions; and
providing, by the input device, the scanning parameter values for each scanning parameter subset,
wherein each vectorized shape defines a respective scanning region of the plurality of scanning regions.
